(19) United States
(12) Patent Application Publication
(10) Pub. No.: US 2007/0249759 A1
(43) Pub. Date: Oct. 25, 2007

(54) Tackifier dispersions with improved humid age performance

(76) Inventor: Peter James Miller, Gray, TN (US)

Correspondence Address: Tammye L. Taylor, Eastman Chemical Company, P.O. Box 511, Kingsport, TN, 37662-5075, US

(21) Appl. No.: 11/787,814

(22) Filed: Apr. 18, 2007

Related U.S. Application Data
(60) Provisional application No. 60/793,797, filed on Apr. 21, 2006.

(51) Int. Cl. C08J 3/00

(52) U.S. Cl. 523/336; 524/270

(57) ABSTRACT

This invention pertains to water based pressure sensitive adhesive label and tape formulations containing tackifier dispersions, with greater than about 2% by weight of non-neutralized low molecular weight carboxylic acid containing compounds, that show improved retention of adhesive properties in conditions of elevated temperature and relative humidity. The low molecular weight carboxylic acid containing compounds serve as scavenger species for migrating multivalent cations such as calcium that are liberated from paper facestocks and backings containing calcium carbonate fillers.

This application claims benefit of provisional application entitled, TACKIFIER DISPERSIONS WITH IMPROVED HUMID AGE PERFORMANCE, Ser. No. 60/793,797, filed Apr. 21, 2006, incorporated by reference herein.

### FIELD OF THE INVENTION

The present invention generally pertains to the field of resin dispersions and to the preparation of adhesives therewith.

### BACKGROUND OF THE INVENTION

Many types of adhesive formulations, especially pressure sensitive adhesives based on synthetic polymers such as acrylic polymers and styrenic block-co-polymers, usually need some kind of tackifier in the formulation. The tackifier improves the adhesive properties such as tackiness, peel-resistance and the ease of surface wetting. The tack of an adhesive enables it to form an immediate bond between contacted surfaces when they are brought together.

Tackifiers are generally based on resins, tackifier resins, which can be considered as high viscosity solvents for a base polymer in a formulation. A tackifier should be seen as a material which relates to a specific material or group of materials that it tackifies.

Various resinous materials have been suggested as tackifier resins for synthetic polymers. Examples of materials suggested include rosin, disproportionated rosin, rosin esters such as glycerol esters of rosin and pentaerythritol esters of rosin, aliphatic hydrocarbon resins, aromatic petroleum resins, DCPD resins, terpene resins, terpene/phenol resins and cumarone/indene resins.

Tackifier resins for pressure sensitive adhesives are usually based on rosin and/or derivatives thereof or hydrocarbon resins. Rosin is a natural resinous product mainly consisting of rosin acids. Typical rosin acids are, for example, abietic acid and levopimaric acid. The difference between the rosin acids is mainly the number and position of the double bonds. Rosin may be classified due to the species of the tree from which it originates such as Chinese, Indonesian, and Brazilian rosin and/or to the production process from which it originates such as gum rosin, wood rosin or tall oil rosin.

Hydrocarbon resins are generally low-molecular weight aliphatic or aromatic polymers typically having a weight average molecular weight of 500-3000. Typically, these resins originate from the oil or natural gas cracking industry.

In aqueous adhesive compositions it is common to include the tackifier resin in the form of an aqueous dispersion. In order to make a dispersion from a resinous material such as rosin or hydrocarbon resin, a surfactant is needed to act as an emulsifier. In the case of rosin and hydrocarbon resins, the aqueous dispersion is usually made by first melting the rosin or hydrocarbon resin and then adding a surfactant and water to form a dispersion in which the rosin/resin is the dispersed phase and water the continuous phase. The resulting tackifier resin dispersions are then combined with the polymers to make the adhesive formulations. In particular, they are used in pressure sensitive adhesives.

In some instances, when waterborne acrylic-based pressure sensitive adhesives (PSA's) are coated on papers containing fillers rich in multivalent cations, they can exhibit a degradation in properties when exposed to warm humid environments for prolonged periods of time. Specifically, the degradation manifests itself in the form of increased edge lift when the “aged” label is applied to a plastic substrate.

Thus, there remains a need in the art to improve the performance of adhesive formulations subject to high temperatures and humidity for prolonged periods of time without impacting the cohesive strength of the adhesive compositions.

### BRIEF SUMMARY OF THE INVENTION

The present invention relates to a process for producing resin dispersions by melting a resin, contacting the resin with a least one surfactant, neutralizing the surfactant(s) with at least one neutralizing agent, adding a low molecular weight carboxylic acid containing compound to the resin mixture, and adding water to invert the dispersions.

The present invention also relates to a process for producing resin dispersions by melting a resin, adding a low molecular weight carboxylic acid containing compound to the resin, contacting the resin mixture with at least one surfactant, and adding water to invert the dispersions.

The present invention further relates to a process for producing tackifier dispersions by dispersing resinous material in an aqueous phase containing at least one neutralized ionic surfactant or at least one nonionic surfactant and introducing about 5% or more by weight of a non-neutralized low molecular weight carboxylic acid containing compound to the resin mixture.

One aspect of the present invention pertains to pressure sensitive adhesive compositions comprising a surfactant, a tackifier resin dispersion, a polymer latex, and water, wherein the dispersion is prepared by a process comprising dispersing one or more of hydrocarbon resins, pentaerythritol, glycerols, or triethylene glycol esters of rosin in an aqueous phase containing a nonylphenol surfactant and introducing about 2% or more by weight of a low molecular weight compound such as rosin acids, hydrogenated rosin acids, modified rosin acids, disproportionated rosin acids or dimerized rosin acids to the resin mixture, wherein the low molecular weight compound acts as a scavenger in the adhesive such that migrating multivalent cations react with the low molecular weight compound instead of crosslinking with the adhesive polymer.

Another aspect of the present invention pertains to pressure sensitive adhesive compositions comprising a surfactant, a tackifier resin dispersion, a polymer latex, and water, wherein the dispersion is prepared by a process comprising dispersing one or more of hydrocarbon resins, pentaerythritol, glycerols, or triethylene glycol esters of rosin in an aqueous phase containing a neutralized ionic surfactant and introducing about 2% or more by weight of a non-neutralized low molecular weight compound such as a rosin acid, a hydrogenated rosin acid, a modified rosin acid, a disproportionated rosin acid or a dimerized rosin acid to the resin mixture, wherein the low molecular weight compound acts as a scavenger in the adhesive such that migrating multivalent cations react with the low molecular weight compound instead of crosslinking with the adhesive polymer.

Another aspect of the present invention pertains to pressure sensitive adhesive overlays prepared by applying a layer of adhesive composition to a surface of a paper substrate, and drying the layer, wherein the adhesive composition comprises a tackifier resin dispersion, a polymer latex, and water, wherein the resin dispersion is prepared by a process comprising: dispersing rosin ester resins in an aqueous phase containing a nonylphenol and introducing about 2% or more by weight of a wood rosin to the resin, wherein the wood rosin acts as a scavenger in the adhesive such that migrating multivalent cations liberated from the substrate react with the wood rosin instead of crosslinking with the adhesive polymer.

A further aspect of the present invention pertains to pressure sensitive adhesive overlays prepared by applying a layer of adhesive composition to a surface of a paper substrate, and drying the layer, wherein the adhesive composition comprises a tackifier resin dispersion, a polymer latex, and water, wherein the resin dispersion is prepared by a process comprising: dispersing rosin ester resins in an aqueous phase containing a neutralized wood rosin and introducing about 2% or more by weight of a non-neutralized wood rosin to the resin, wherein the wood rosin acts as a scavenger in the adhesive such that migrating multivalent cations liberated from the substrate react with the wood rosin instead of crosslinking with the adhesive polymer.

A further aspect of the present invention pertains to the use of the tackifier dispersions, in combination with polymer latexes to prepare adhesives. The adhesives according to the present invention may be employed in the following fields: labels on any kind of surface, packaging applications, flooring adhesives, road markings or any type of water-based tapes, barrier coatings or sealants.

### DETAILED DESCRIPTION

The present invention may be understood more readily by reference to the following detailed description of the invention and to the Examples included therein.

Before the present compositions of matter and methods are disclosed and described, it is to be understood that this invention is not limited to specific synthetic methods or to particular formulations, unless otherwise indicated, and, as such, may vary from the disclosure. It is also to be understood that the terminology used is for the purpose of describing particular embodiments only, and is not intended to limit the scope of the invention.

The singular forms “a”, “an”, and the “the” include plural referents, unless the context clearly dictates otherwise.

Optional or optionally means that the subsequently described events or circumstances may or may not occur. The description includes instances where the events or circumstances occur, and instances where they do not occur.

Ranges may be expressed herein as from about one particular value, and/or to about another particular value. When such a range is expressed, it is to be understood that another embodiment is from the one particular value and/or to the other particular value, along with all combinations within said range.

Throughout this application, where patents or publications are referenced, the disclosures of these references in their entireties are intended to be incorporated by reference into this application, in order to more fully describe the state of the art to which the invention pertains.

Some relevant technical terms as used in the context of the present invention are meant to be understood as follows (unless specifically indicated otherwise throughout the description).

“Surfactants” (a term understood to be synonymous with the term “emulsifier” for the purposes of the present invention) in the meaning of the present invention provide stability and prevent coalescence of particles formed during emulsification. Surfactants furthermore prevent the coagulation or aggregation of particles in the final dispersion. Due to their amphiphilic character, surfactant molecules have an affinity for both oil and water phases. As a result, a balance exists between surfactant molecules present at the oil-water interface and molecules present in the oil and water phases.

“Tackifier” in the meaning of the present invention pertains to any of several compositions useful for imparting tack to adhesive compositions. The terms “tackifier dispersion”, “resin dispersion”, and “tackifier resin dispersion” are used interchangeably.

“Adhesion” (or adhesive properties) in the meaning of the present invention relate(s) to the interaction of the adhesive formulation with the substrate to which it is applied. Characteristically, adhesive forces mainly concern the interface between adhesive and substrate. Suitable tests to measure adhesion are, for example, the “loop tack” test and the “peel strength” test. These tests are described in the FINAT Technical Handbook, 6^{th} edition, 2001. Loop tack is measured according to FINAT Test Method (FTM) 9 (page 22 et seq. of the Handbook). Peel Strength is measured according to FTM 1 (page 6 et seq. of the Handbook).

“Cohesion” (or cohesive properties) in the meaning of the present invention relates to interaction/forces within the adhesive. Typically, cohesive forces mainly concern the bulk phase of the adhesive. A suitable test to measure cohesion is the “shear cohesion” test. Shear Cohesion is measured according to FTM 8 (page 20 et seq. of the Handbook).

A “rosin acid” according to the present invention is understood to comprise a mixture of various rosin acid molecules. Mixtures of this kind that are readily available and occur in nature include, but are not limited to, tall oil rosin, gum rosin or wood rosin. These natural mixtures may comprise rosin acids of the abietic type and/or the pimaric type such as abietic acid, palustric acid, neoabietic acid, levopimaric acid, pimaric acid, isopimaric acid or dehydroabietic acid, among others, in varying amounts. In addition to rosin acids with one carboxylic acid functionality, rosin acids with two or more carboxylic acid functionalities are also considered as rosin acids in the meaning of the present invention.

A “rosin acid derivative” according to the present invention is any molecule that has the molecular rosin acid backbone but is modified in at least one of the following ways. In one embodiment, at least one double bond is hydrogenated (hydrogenation). In another embodiment, at least one of the rings of the rosin and backbone is dehydrogenated so that an aromatic ring results (dehydrogenation). In yet another embodiment, adducts to the conjugated double bonds of the rosin acid backbone are included, in particular the addition of maleic anhydride in a Diels-Alder type reaction. The resulting adduct is considered one type of a rosin acid derivative according to the present invention.

A “rosin ester” according to the present invention is any molecule in which at least two rosin acid or rosin acid derivative units are connected by means of at least two ester linkages. Any molecule with at least two hydroxyl groups can be used to provide the ester linkage between at least two rosin acids units. Common examples include, but are not limited to, glycerol esters, pentaerythritol esters and (triethylene) glycol esters.

The “solid content” of a tackifier resin dispersion is given in % weight per overall weight of the dispersion (unless indicated otherwise).

“Water-based” tackifier resin dispersions according to the present invention are dispersions of tackifier entities wherein the solvent is generally water or an aqueous solution. However, mixtures of water with a non-aqueous solvent, in particular an organic solvent, would also be suitable as long as the foaming properties or other dispersion properties are not negatively affected. Mixtures of water with other water-soluble solvents could also be used as well.

Generally, in some instances, when waterborne acrylic-based pressure sensitive adhesives (PSA's) are applied to paper facestocks in label and tape applications or when they are coated on papers containing fillers rich in multivalent cations, they can exhibit a degradation in properties when exposed to warm humid environments for prolonged periods of time. Specifically, the degradation manifests itself in the form of increased edge lift when the “aged” label is applied to certain substrates. For example, plastic mandrels of rather small diameter such as pharmaceutical bottles. Without being bound by any theory, this degradation occurs when adhesive polymers crosslink with migrating multivalent cations, such as calcium from calciumcarbonate, that may be liberated from the paper facestocks and backing containing fillers.

One aspect of the present invention pertains to a method to incorporate low molecular weight carboxylic acid containing compounds into typical tape or label adhesive formulations to act as a scavenger or a “sacrificial species”. Without being bound by any theory, the low molecular weight carboxylic acid containing species in the adhesive formulations act as scavengers that reacts with the multivalent cations and prevents the crosslinking reaction with the adhesive, thereby preserving the adhesive strength of the adhesive.

One aspect of the present invention pertains to the introduction of a sacrificial species in an adhesive formulation that is both mobile, i.e. low molecular weight, and at sufficient concentration that cation complexation with the sacrificial species is preferable to complexation with the polymer in the adhesive. Another aspect of the present invention pertains to a method to incorporate the sacrificial species into the adhesive by incorporating it in the tackifer dispersion that is used to make the adhesive.

One embodiment of the present invention relates to a process for producing resin dispersions that include this inventive sacrificial species. This process produces a resin dispersion that includes an additional low molecular weight carboxylic compound to act as a scavenger in the resulting adhesive formulation such that migrating multivalent cations liberated from the substrate react with the low molecular weight compound instead of crosslinking with polymers in the adhesive.

One embodiment of the present invention provides a process for producing a resin dispersion by melting a resin, contacting the resin with at least one surfactant, neutralizing the surfactant(s) with at least one neutralizing agent, adding a low molecular weight carboxylic acid containing compound to the resin mixture, and adding water to invert the dispersion.

Another embodiment of the present invention provides a process for producing a resin dispersion by melting a resin, adding a low molecular weight carboxylic acid containing compound to the resin, contacting the resin mixture with at least one surfactant, and adding water to invert the dispersion.

The melting of the resins or the resinous material according to the present invention may be carried out by any conventional method known in the art. For example, in one embodiment, the resins or resinous material may be heated or melted at a temperature from about 50° C. to about 200° C. By further example, in another embodiment, the resins or resinous material may be heated approximately 10° C. to 30° C. above the softening point of the resin or the mixture of resins.

In general, the tackifier resins can be characterized by a Ring and Ball softening point ranging from about 40° C. to about 180° C.; for example, from about 50° C. to about 120° C., or from about 70° C. to about 140° C. Typically, for resins or mixtures of resins with a Ring and Ball softening point of greater than about 100° C., the process is carried out under pressurized conditions.

Any resins or resinous material conventionally used as tackifiers in resin dispersions are suitable for use according to the present invention. Suitably, for example, rosin esters may be used as the resinous material in the present invention. By further example, the tackifier resins can be selected from the group consisting of hydrocarbon resins, pentaerythritol, glycerol, triethylene glycol esters of rosin, or mixtures thereof.

Suitable resins include, but are not limited to, (1) esters of natural and modified rosins and the hydrogenated derivatives thereof; (2) polyterpene resins and hydrogenated polyterpene resins; (3) aliphatic petroleum hydrocarbon resins and the hydrogenated derivatives thereof; (4) aromatic hydrocarbon resins and the hydrogenated derivatives thereof; and (5) alicyclic petroleum hydrocarbon resins and the hydrogenated derivatives thereof, (6) low molecular weight acrylic acid ester co-polymers and derivatives thereof, or (7) low molecular weight urethane-acrylates and derivatives thereof. Mixtures of two or more of the above-described resins suitably may be used in some embodiments.

Suitably, in other embodiments, the rosin can be an unmodified or a modified rosin. There are many different ways of modifying rosins. For example, the rosin can be esterified. In some embodiments, the rosin is a glycerol, pentaerythritol or triethylene glycol ester of a rosin acid. Suitably, in other embodiments, any low molecular weight compounds containing multiple hydroxyl groups could be used to produce rosin esters.

In some embodiments, suitable hydrocarbon resins include aliphatic or aromatic hydrocarbon resins, DCPD resins, terpene resins, and terpene/phenol resins. Aliphatic resins according to the present invention are defined as tackifiers produced from at least one monomer selected from alkanes, alkenes, and alkynes. These monomers can be straight chains or branched. For example, an aliphatic resin can be produced by polymerizing cis- and trans-piperylene, isoprene, and dicyclopentadiene. Examples of aliphatic resins include, but are not limited to, Piccotac® 1095 from Eastman Chemical; Hikorez® C-110 available from Kolon Industries; and Wingtack® 95 available from Goodyear Chemical. Hydrogenated cycloaliphatic resins include, but are not limited to, Eastotac® H-100, Eastotac® H-115, Eastotac® H-130, and Eastotac® H-142 available from Eastman Chemical. These tackifier resins have Ring and Ball softening points of 100° C., 115° C., 130° C., and 142° C., respectively. The Eastotac® resins are available in various grades (E, R, L and W) that differ in the level of hydrogenation.

Aromatic hydrocarbon resins according to the present invention are defined as hydrocarbon resins produced from at least one unsaturated cyclic hydrocarbon monomer having one or more rings. For example, aromatic hydrocarbon resins can be produced from polymerizing indene or methylindene with styrene or methylstyrene in the presence of a Lewis acid. Commercial examples of aromatic hydrocarbon resins include, but are not limited to, Kristalex® 3100 and Kristalex® 5140 available from Eastman Chemical. Hydrogenated aromatic resins include, but are not limited to, Regalrez® 1094 and Regalrez® 1128 available from Eastman Chemical.

Aliphatic-aromatic tackifier resins according to the present invention are produced from at least one aliphatic monomer and at least one aromatic monomer. Aliphatic monomers and aromatic monomers were defined previously in this disclosure. Examples of aliphatic-aromatic tackifier resins include, but are not limited to, Piccotace 9095 available from Eastman Chemical and Wingtack® Extra available from Goodyear Chemical. Hydrogenated aliphatic-aromatic resins include, but are not limited to, Regalite® V3100 available from Eastman Chemical and Escorez® 5600 available from Exxon Mobil Chemical.

Polyterpene resins according to the present invention are defined as tackifier resins produced from at least one terpene monomer. For example, alpha.-pinene, .beta.-pinene, d-limonene, and dipentene can be polymerized in the presence of aluminum chloride to provide polyterpene tackifier resins. Other examples of polyterpene tackifier resins include, but are not limited to, Sylvares® TR 1100 available from Arizona Chemical, and Piccolyte® A125 available from Pinova.

Examples of aromatically modified terpene resins include, but are not limited to, Sylvares® ZT 105LT and Sylvares® ZT 115LT available from Arizona Chemical.

Any organic carboxylic acid containing compound in a non-neutralized form would be suitable for use as the low molecular weight sacrificial species according to the present invention. In one embodiment, the low molecular weight carboxylic acid containing compound, must be retained in the adhesive formulation during and after water removal, i.e. it most have low volatility. In another embodiment, the carboxylic acid containing compound must also be compatible with both the resin as well as the polymer emulsion in the adhesive formulation. The tackifier dispersions according to the present invention may contain greater than about 2% by weight of the carboxylic acid containing compound in a non-neutralized form based on the total weight of the resins. For example, the tackifier dispersion according to the present invention may contain greater than 5% by weight or even greater than 10% by weight of the carboxylic acid containing species based on the total weight of resins. In one embodiment, the low molecular weight carboxylic acid containing compound is added to the tackifier dispersion in an amount up to about 20% by weight, for example up to about 10%. In another embodiment, the low molecular weight carboxylic acid containing compound is added to the tackifier dispersion in an amount from about 2% to about 20% by weight.

According to the present invention, suitable carboxylic acid containing compounds include, but are not limited to, (1) natural and modified rosins and the hydrogenated derivatives thereof, (2) low molecular weight acrylic acid co-polymers, or (3) fatty acids.

In some embodiments of the present invention, the carboxylic acid containing species is suitably a rosin. For example, in some embodiments the rosins may comprise rosin acids. Generally, rosins acids are mixtures of C₂₀ monobasic carboxylic acids containing a phenanthrene skeleton.

Rosin acids include rosins and rosin derivatives obtained from naturally occurring sources such as tall oil rosin, gum rosin, or wood rosin, dimerized rosins and polymerized rosins. Fractions or mixtures of these sources may be used as well. The mixtures may be a combination of two or more of the natural products with each other or the natural products may be mixed with purified or synthetically produced rosin acids as well. No limitations exist with respect to the degree of hydrogenation, dehydrogenation or the variation of any of the functional groups that may be attached to the rosin acid as long as the carboxyl-functionality remains intact for at least some of the molecules.

In one embodiment, the carboxylic acid species may include, but are not limited to, one or more of the following: rosin acids, hydrogenated rosin acids, disproportionated rosin acids, dimerized rosin acids, or modified rosin acids such as those modified with maleic, fumaric or phenolic functionalities.

Examples of suitable rosins and rosin derivatives include, but are not limited to, Foral® AX-E, Foralyn® 90, Dymerex® resin, Polystix® 90 and Permalyn® 3100 available from Eastman Chemical. Other useful examples are Sylvatac® RE 4216 and Sylvatac® RE 85 available from Arizona Chemical.

Suitably, unsaturated fatty acids such as, for example, myristoleic acid, palmitoleic acid, oleic acid, linoleic acid, alpha-linolenic acid, arachidonic acid, eicosapentaenoic acid, erucic acid, or docosahexaenoic acid also may be used as the carboxylic acid containing species according to the present invention. By further example, saturated fatty acids such as, for example, butyric (butanoic acid), caproic (hexanoic acid), caprylic (octanoic acid), capric (decanoic acid), lauric (dodecanoic acid), myristic (tetradecanoic acid), palmitic (hexadecanoic acid), stearic (octadecanoic acid), arachidic (icosanoic acid), or behenic (docosanoic acid) suitably may be used as the carboxylic acid containing species according to the present invention.

Any conventional surfactant or combination of surfactants is suitable for use in the present invention. Suitably, ionic (ie. ionizable) surfactants or nonionic (ie nonionizable) surfactants may be used in various embodiments of the present invention. For example, suitable nonionic surfactants include, but are not limited to, any long chain ethyoxylate block copolymers, any hydroxyl terminal long chain ethoxylates, alcohol ethoxylates, alkyl ethoxylates, alkyl phenols, alkyl phenol ethoxylates, alkyl alcohol ethoxylates, alkyl sulphonates, fatty alcohol sulphates, and alkyl phenol ethoxylate phosphates, or phosphate esters.

Examples of suitable alkyl phenol ethoxylates include, but are not limited to, nonylphenol ethoxylate phosphates. The term ‘nonylphenol’ represents a large number of isomeric compounds of the general formula HOC₆H₄C₉H₁₉. Commercially produced nonylphenols are predominantly 4-nonylphenol with a varied and undefined degree of branching in the attached alkyl group, alkylsulfonic acid, fatty acid, oxyethylated alkyphenol and derivatives, or mixtures thereof.

Examples of suitable nonionic surfactants include, but are not limited to, fatty alkanolamide; oleyl diethanolamide; lauryl diethanolamide; coconut diethanolamide; fatty diethanolamide; lauramide dealauryl diethanolamide; PEG-6 lauramide; lauryl/myristyl monoethanolamide; oleic diethanolamide; alkyl ether phosphate; glycerol monooleate; polyglyceryl-10 decaoleate; polyglycerol esters; polyglycerol polyricinoleate; caprylic/capric triglyceride; caprylic triglyceride; tridecyl alcohol phosphate ester; nonylphenol ethoxylate phosphate ester; cetyl palmitate; butoxy ethyl stearate; butyl stearate; methyl laurate; methyl palmitate/oleate; PEG-2 stearate; glyceryl oleate; glyceryl stearate; isopropyl myristate; isopropyl palmitate; ethylhexyl isononanoate; PEG-4 dioleate; PEG-8 dilaurate; PEG-8 dioleate; PEG-8 distearate; PEG-8 laurate; PEG-8 oleate; PEG-8 stearate; PEG-12 dilaurate; PEG-12 dioleate; PEG-12 distearate; PEG-12 laurate; PEG-150 distearate; PEG-150 stearate; propylene glycol stearate; nonylphenol POE 10 phosphate ester; nonylphenol POE 6 phosphate ester; nonylphenol POE 8 phosphate ester; nonylphenol POE-12 phosphate ester; soybean oil, methyl ester; fatty alkyl ethoxylate; fatty alcohol ethoxylate; fatty acid ethoxylate; alcohol ethoxylate; tallow amine ethoxylate, POE-2; octyl phenol 12 mole ethoxylate; nonyl phenol 1.5 mole ethoxylate; nonyl phenol 4 mole ethoxylate; nonyl phenol 6 mole ethoxylate; nonyl phenol 9 mole ethoxylate; nonyl phenol 10 mole ethoxylate; nonyl phenol 10.5 mole ethoxylate; nonyl phenol 12 mole ethoxylate; nonyl phenol 15 mole ethoxylate; nonyl phenol 30 mole ethoxylate; nonyl phenol 40 mole ethoxylate; castor oil ethoxylate; castor oil 40 mole ethoxylate; octyl phenol 5 mole ethoxylate; octyl phenol 7 mole ethoxylate; octyl phenol 9 mole ethoxylate; octyl phenol 12 mole ethoxylate; octyl phenol 40 mole ethoxylate; octyl phenol ethoxylate; decyl alcohol ethoxylate, POE-4; decyl alcohol ethoxylate, POE-6; decyl alcohol ethoxylate, POE-9; tridecyl alcohol ethoxylate; tridecyl alcohol ethoxylate, POE-12; tridecyl alcohol ethoxylate, POE-18; tridecyl alcohol ethoxylate, POE-3; tridecyl alcohol ethoxylate, POE-6; tristyrylphenol ethoxylate; fatty acid ethoxylate, POE-3; fatty acid ethoxylate, POE-10; fatty acid ethoxylate, POE-15; octylphenol ethoxylate, 30 EO; octylphenol ethoxylate, 40 EO; tristyrylphenol ethoxylate POE-16 phosphate ester; ethoxylated coco amine; sorbital trioleate ethoxylate, POE 20; sorbital monooleate ethoxylate, POE 20; tallow amine ethoxylate, POE-15; tallow amine ethoxylate, POE-2; or tallow amine ethoxylate, POE-5.

Suitably, ionic surfactants also may be used in some embodiments of the present invention. For example, in one embodiment, the surfactants may be any ionizable organic compounds whose neutralized salts are amphiphilic in nature, such as, for example, any carboxylic acid containing compound, any phosphoric acid containing compound, any sulfuric acid containing compound, any alkyl sulphonates, any fatty alcohol sulphate containing compounds, any sulfonic acid containing compound, any sulfonate succinic acid containing compound, any sulfosuccinic acid containing compound, or any sulfosuccinamic acid containing compound, or any disulfosuccinic acid containing compound.

For example, the following surfactants would be suitable for use as ionic surfactants according to the present invention: alkyldiphenyloxide disulfonate, sodium dodecylbenzene sulfonate; (neutralized)dodecylbenzene sulfonic acid; potassium dodecylbenzene sulfonate; sodium dodecylbenzene sulfonate; ammonium nonylphenol ethoxylate sulfate; sodium nonylphenol ethoxylate sulfate; sodium lauryl ether sulfate; ammonium lauryl ether sulfate; sodium decyl sulfate; sodium lauryl sulfate; sodium octyl sulfate; sodium tridecyl sulfate; sodium tridecyl ether sulfate; potassium oleate sulfonate; tridecyl alcohol phosphate ester; tridecyl alcohol ethoxylate; sodium dioctyl sulfonate succinate; tristyrylphenol ethoxylate-POE-16 phosphate ester, potassium salt, tristyrylphenol ethoxylate-POE-16 phosphate ester, amine salt; magnesium lauryl sulfate; sodium decyl sulfate; sodium 2-ethyl hexyl sulfate; sodium C14-16 olefin sulfonate; tetrasodium dicarboxyethyl stearyl sulfosuccinamate; sodium alkyl sulfonates; sodium octyl sulfate; alkyl napthalene sulfonate; sodium tridecyl ether sulfate; triethyl ammonium lauryl sulfate; sodium decylglucosides hydroxypropyl sulfonate; sodium decylglucosides hydroxypropyl sulfonate; sodium laurylglucosides hydroxypropyl sulfonate; sodium didecylglucosides hydroxypropyl phosphate; sodium dilaurylglucosides hydroxypropyl phosphate; sodium dibutylglucosides hydroxypropyl phosphate; potassium monoalkyl phosphate; triethanolamine monoalkyl phosphate; sodium dioctyl sulfosuccinate; sodium decyl diphenyl oxide disulfonate; disodium oleamido MEA sulfosuccinate; disodium ricinoleamido MEA sulfosuccinate; ammonium lauryl sulfosuccinate; sodium dodecyl diphenyl oxide disulfonate;; sodium ditridecyl sulfosuccinate; sodium laureth sulfate (2 EO); sodium laureth sulfate; ammonium lauryl sulfate; ammonium laureth sulfate; TEA-lauryl sulfate; TEA-laureth sulfate; MEA-lauryl sulfate; MEA-laureth sulfate; potassium lauryl sulfate; potassium laureth sulfate; sodium decyl sulfate; sodium octyl/decyl sulfate; sodium 2-ethylhexyl sulfate; sodium octyl sulfate; α-olefin sulfonate; sodium α-olefin sulfonate; alkyl phonol ether sulfate; sodium nonoxynol-4 sulfate; sodium nonoxynol-6 sulfate; or ammonium nonoxynol-6 sulfate.

Examples of suitable alkyl aryl sulphonates include, but are not limited to, sodium or ammonium alkyl benzene sulphonates, fatty alcohol sulphates, e.g. sodium lauryl sulphate, salts of mono- and di-esters of orthophosphoric acid, sodium salts of sulphated monoglycerides and sulphonates or sulphosuccinates of alkyl phenol polyoxyalkylene oxide condensates or of polyoxyalkylene oxide condensates, e.g. the ammonium salt of nonylphenol polyethylene oxide sulphonic acid.

By further example, the surfactant may be any carboxylic acid containing compound whose neutralized salt is amphiphilic such as a rosin acid. Embodiments using rosin acids in the dispersion are particularly useful in the resulting adhesive formulations because the rosin acid serves a dual function both as a surfactant in its neutralized form during the dispersion inversion process and as a tackifier and a low molecular weight scavenger in its non-neutralized form when the resulting dispersion is incorporated into an adhesive formulation. In some embodiments, only a portion of the rosin acid is neutralized to function as a surfactant and the remaining portion is not neutralized and may function as the low molecular weight carboxylic acid scavenger species according to the present invention. For example, wood rosins would be suitable for use as both a surfactant and a low molecular weight scavenger species according to the present invention.

In one embodiment of the present invention, at least one of the ionic surfactants should also be neutralizable with a suitable counter ion either partially or completely. In one embodiment of the present invention the surfactant is neutralized by a neutralizing agent, but the low molecular weight compound remains in a non-neutralized state. Any conventional neutralizing agent is suitable for use according to the present invention. Suitably, the neutralizing agent or ionizing agent, may or may not be a readily volatilizable material, such as, for example, ammonium hydroxide, amines, or hydroxyl amines, but it may also be a base such as an alkali metal hydroxide or alkaline earth metal hydroxide. For example, suitable neutralizing agents include NaOH, KOH, or NH₄OH. Also, the neutralizing agent may be a mixture of two volatile bases or a mixture of nonvolatile bases.

For example, in one embodiment the process for producing a tackifier dispersion comprising dispersing resinous material such as rosin ester resins in an aqueous phase containing at least one neutralized ionic surfactant or at least one nonionic surfactant and introducing about 2% or more by weight of a non-neutralized low molecular weight carboxylic acid containing compound to the resin mixture.

Any conventional method for producing dispersions may be used according the present invention. In general, to produce the dispersion, the resinous material is contacted with one or more surfactants and water by any method known in the art.

In one embodiment, the resin dispersion may be produced by a batch inversion process. In another embodiment, they may be produced using a continuous process.

In another embodiment, the resin or mixture of resinous materials may be heated to approximately 10° C. to 30° C. above the softening point of the resin/the mixture of resin. The surfactants according to the present invention then may be added to the resin/resin mixture. In one embodiment, the carboxylic acid containing species is added to the resinous material at this point. In a further embodiment, the surfactants may be added together with a suitable neutralizing agent. Alternatively, in one embodiment, the carboxylic acid containing species are added to the neutralized surfactant/resin mixture.

Typically, the surfactants are added so as to be present in the resin dispersion in an amount of suitably from about 2% to about 15% by weight, based on the weight of resinous material, for example from about 5% to about 10% by weight. Sufficient hot water, suitably from about 5% to about 15% by weight, based on the weight of resinous material, is stirred in to form a creamy water-in-oil emulsion. Upon dilution with water, suitably in an amount of from about 10% to about 35% by weight, based on the weight of resinous material, for example from about 15% to about 30% by weight, or from about 20% to about 25% by weight, the emulsion inverts to provide a stable oil-in-water emulsion. The dispersion is suitably further diluted with water until the desired solids content is reached.

In a further step, water may be slowly added to the resin tackifier mixture under agitation until phase inversion is reached. In one embodiment, the resulting emulsion is further diluted to the desired total solid content. The resulting dispersion is then slowly cooled under gentle agitation.

The amount of surfactant added to the resinous material is suitably between about 4 to about 9 parts, such as, for example, from about 5 to about 8 parts, per 100 parts tackifier, respectively (in parts per weight). The amount of neutralizing agent added is adjusted in a manner so that the final dispersions have pH values ranging from about 4 to about 12 or from about 6 to about 10.

The average particle size of the tackifiers in the tackifier dispersions as discussed above is suitably less than about 10 μm. For example, the average particle size of the tackifier is less than about 2 μm or less than about 1 μm or even less than about 500 nm. In another embodiment, the average particle size of the tackifiers is less than about 250 nm. Generally, particle sizes and particle size distributions are measured with (laser) light scattering methods.

In a further embodiment, the resin dispersions have a Brookfield viscosity of less than about 6000 cPs or less than about 4000 cPs. Generally, viscosities are measured with a Brookfield LVT Viscometer. Surfactants with higher viscosities are covered by the present invention as long as the foam behavior is acceptable and the solid content is within the specified ranges.

For example, the viscosity of the tackifier dispersion is suitably adapted to the specific use but is suitably, measured as Brookfield (spindle 3@50 rpm) at 20° C., from about 100 to about 6000 cPs, such as from about 500 to about 5000 cPs, or from about 1000 to about 4000 cPs.

The solids content, i.e. the dry content of resinous material and surfactants, in the tackifier dispersion is suitably at least about 20% by weight up to the maximum content achievable such as, for example, at least about 50% to about 70% by weight, or even from about 55% to about 65% by weight.

The tackifier dispersion according to the invention typically has a storage stability (shelf life) of at least about one year and will suitably demonstrate no substantial separation, coagulation or deposition. It is also preferred that the dispersion is low foaming and have good mechanical stability during pumping, transportation and mixing, as well as low foaming and good stability when formulated in an adhesive composition and during coating of the adhesive composition.

In another aspect of the present invention, the resin dispersions produced according to the present invention can be used to prepare adhesive compositions. The inventive resin dispersions according to the present invention result in improved cohesion and adhesion properties of water-based adhesives prepared with said tackifier dispersions. For example, such adhesives can be advantageously used in the labeling and packaging industries, for any type of water-based tapes, road markings and flooring applications. In the aforementioned applications, the adhesives are pressure-sensitive. Other applications, in which the adhesive is not pressure sensitive, are included as well. Such applications include, but are not limited to barrier coatings or sealants.

According to the present invention, the adhesive formulation comprises at least one inventive tackifier dispersion as described above and at least one polymer component. In general, the polymer component may be a polymer dispersion or a latex emulsion. Accordingly, the terms latex, polymer latex, acrylic latex, polymer dispersion, emulsion polymer, polymer emulsion, or latex emulsion may be used interchangeably when describing the polymer component of the adhesive formulations. For example, the polymer component is an elastomeric polymer including elastomeric latexes, such as acrylics or styrene-butadiene rubber. Other polymers suitable for use with the tackifier dispersions according to the present invention include but are not limited to:
suspensions of natural rubber,
acrylic polymers derived from 2-ethylhexyl acrylate, butyl acrylate, methyl methacrylate, methacylic acid, and acrylic acid or mixtures thereof,
styrene-butadiene copolymers,
polymers derived from vinyl acetate, such as ethylene vinyl acetate,
poly chloroprene, or
acrylonitrile-butadiene copolymers.

### Any mixture of two or more of these polymers could suitably be used as well.

In another embodiment of this invention, a process is provided to produce the adhesive composition. The process comprising contacting at least one tackifier resin dispersion, and at least one polymer latex. The contacting can be conducted by any method known in the art.

In one embodiment of the present invention, in order to prepare the inventive wet adhesive formulation (i. e. water-based), a tackifier dispersion according to the present invention and a polymer latex may be blended. Generally, the adhesive formulation consists of about 10% to about 60% of tackifier, such as for example about 20% to about 40% (based on dry weight).

The invention further relates to an aqueous adhesive composition comprising one or more polymers and the tackifier dispersion according to the invention. In one embodiment, the aqueous adhesive compositions are pressure sensitive adhesive (PSA) compositions. The aqueous adhesive composition suitably comprises from about 40 to about 90 weight % of a synthetic polymer latex or natural rubber latex, and from about 10 to about 60 weight % of the tackifier dispersion.

One embodiment of the present invention provides a water based pressure sensitive adhesive formulation that contains the inventive resin dispersion compounded with a polymer latex at a concentration of about 10% to about 60% on a dry weight basis.

Suitable polymers in the aqueous adhesive composition are natural and synthetic rubbers such as polychloroprene rubber, styrene-butadiene rubbers, SIS block copolymers, SBS block copolymers, VAE (vinylacetate ethylene copolymers), nitrile rubbers and polyisobutylene rubbers, acrylate polymers, acrylic polymers such as acrylic esters and methacrylate polymers or mixtures thereof. Preferred polymers used in the aqueous adhesive composition according to the invention are acrylic polymers and/or acrylic ester copolymers. Other compounds known to the person skilled in the art may also be included in the aqueous adhesive composition exemplified by wetting agents, biocides, plasticizers, stabilizers, antioxidants, fillers, coloring agent and the like. The amounts of polymers/copolymers and other compounds contained in the adhesive compositions are not critical and may vary so as to give the preferred properties of the adhesive composition. The compounds can be in any physical state guided by the state of the adhesive composition such as dispersed in an aqueous phase, liquid or solid.

Various additives can be added to the adhesive composition to give desired properties or for preventing degradation, or for any other purpose. Such additives include, but are not limited to, stabilizers, reinforcing agents, fire retardants, foaming agents, conventional tackifiers, plasticizers, oils, antioxidants, polymers, curable/reactive monomers, crosslinking agents, fillers, dyes, pigments, biocides and wetting agents Because of the number of possible compounding ingredients, the properties of the adhesive composition prepared according to this invention can be varied to satisfy most foreseeable requirements for tack, peel strength, shear strength, and solvent media resistant, on whatever combination of substrate is utilized.

In one embodiment of the present invention, the adhesive compositions can be applied to a substrate by being coated onto the surface of the substrate and then contacted with another surface which is a second substrate or second surface of the same substrate. Suitable substrates include, but are not limited to, plastic, paper, corrugated board, chip board, cardstock films, and filmic materials. Conventional coating methods including, but not limited to, gravure, reverse gravure, slot dye or rod coating may be used according to the present invention.

In a further aspect, the present invention is directed to a pressure sensitive adhesive overlay, prepared by applying a layer of a disclosed adhesive composition to a surface of a substrate, serving as an adhesive carrier, and drying the layer. As used herein, the term “overlay” refers to any substrate having a layer of adhesive material applied to at least a portion of its surface (“first surface”) and, thereby, adapted to be adhesively applied to a surface of another substrate (“second surface”) by bringing the first and second surfaces into contact under pressure.

In one embodiment of the present invention, the adhesive formulations can be waterborne adhesives used for the manufacture of pressure sensitive adhesives (PSAs) for adhesive overlays such as labels, tapes, decorative appliques, and the like. Suitable substrates serving as adhesive carriers may be prepared using non-woven material such as, for example, paper, plastic, metal or foam; or may be prepared using woven material, such as, for example, woven cotton or woven synthetic polymers. Some examples of the latter are polyethylene, polypropylene, polyvinyl chloride, polyester, and polyamide.

One embodiment of the present invention pertains to a pressure sensitive adhesive composition comprising a surfactant, a tackifier resin dispersion, a polymer latex, and water, wherein the dispersion is prepared by a process comprising dispersing one or more of hydrocarbon resins, pentaerythritol, glycerols, or triethylene glycol esters of rosin in an aqueous phase containing a nonylphenol surfactant and introducing about 2% or more by weight of a low molecular weight compound such as rosin acids, hydrogenated rosin acids, modified rosin acids, disproportionated rosin acids or dimerized rosin acids to the resin mixture, wherein the low molecular weight compound acts as a scavenger in the adhesive such that migrating multivalent cations react with the low molecular weight compound instead of crosslinking with the adhesive polymer.

Another embodiment of the present invention pertains to a pressure sensitive adhesive composition comprising a surfactant, a tackifier resin dispersion, a polymer latex, and water, wherein the dispersion is prepared by a process comprising dispersing one or more of hydrocarbon resins, pentaerythritol, glycerols, or triethylene glycol esters of rosin in an aqueous phase containing a neutralized ionic surfactant and introducing about 2% or more by weight of a non-neutralized low molecular weight compound such as a rosin acid, a hydrogenated rosin acid, a modified rosin acid, a disproportionated rosin acid or a dimerized rosin acid to the resin mixture, wherein the low molecular weight compound acts as a scavenger in the adhesive such that migrating multivalent cations react with the low molecular weight compound instead of crosslinking with the adhesive polymer.

A further embodiment of the present invention pertains to a pressure sensitive adhesive overlay prepared by applying a layer of adhesive composition to a surface of a paper substrate, and drying the layer, wherein the adhesive composition comprises a tackifier resin dispersion, a polymer latex, and water, wherein the resin dispersion is prepared by a process comprising: dispersing rosin ester resins in an aqueous phase containing a nonylphenol and introducing about 2% or more by weight of a wood rosin to the resin, wherein the wood rosin acts as a scavenger in the adhesive such that migrating multivalent cations liberated from the substrate react with the wood rosin instead of crosslinking with the adhesive polymer.

A further embodiment of the present invention pertains to a pressure sensitive adhesive overlay prepared by applying a layer of adhesive composition to a surface of a paper substrate, and drying the layer, wherein the adhesive composition comprises a tackifier resin dispersion, a polymer latex, and water, wherein the resin dispersion is prepared by a process comprising: dispersing rosin ester resins in an aqueous phase containing a neutralized wood rosin and introducing about 2% or more by weight of a non-neutralized wood rosin to the resin, wherein the wood rosin acts as a scavenger in the adhesive such that migrating multivalent cations liberated from the substrate react with the wood rosin instead of crosslinking with the adhesive polymer. The overlays prepared according to the present invention may maintain their cohesive strength over time with little or no edge lift from plastic mandrels following humid age exposure of labels affixed with the overlays.

This invention can be further illustrated by the following examples of potential embodiments thereof, although it will be understood that these examples are included merely for the purposes of illustration and are not intended to limit the scope of the invention unless otherwise specifically indicated. Parts and percentages mean parts by weight and percentages by weight, unless otherwise specified.

### EXAMPLES

### Resin Dispersion 1—No Additional Rosin Acid:

A 1 gallon Ross mixer, equipped with a stationary cowles agitator 2 inches off center and an anchor blade capable of wiping material from the bottom and sides of the vessel, was charged with 2000 g of a rosin ester resin. The heating oil running through the walls of the vessel was heated to 120° C. to melt the resin. Once melted, the process temperature was reduced to 85° C. 170 g of a nonylphenol ethoxylate phosphate was added to the stirring resin. Following this procedure, 34 g of a 98% solution of triethanol amine was added and the mixture was stirred for ten minutes. The temperature was reduced to 80° C. Deionized water heated to greater than 80° C. was added to the resin blend in 100 mL increments. After 1800 mL of water was added, the resin dispersion was cooled to less than 40° C. and filtered through a 180 μm sieve. The dispersion had a total solids content of 50%, pH of 9.2, and a mean particle diameter of 310 nm measured on a Microtrac UPA 150 laser diffraction instrument.

### Resin Dispersion 2—2% Additional Rosin Acid:

A 1 L resin kettle was charged with 392 g of a rosin ester resin and 2 g of butylated hydroxy toluene. The kettle was placed into a 120° C. oven until the resins were melted. Upon removal of the flask from the oven, the kettle was inserted into a heating mantle. An agitator and thermocouple were place into the flask and the molten resin blend was heated with stirring. When the temperature decreased to below 89° C., 13 g of oleic acid was added to the flask. Following approximately 5 minutes of agitation, 8 g of 45% potassium hydroxide was added to the resin mixture. Following another 5 minute mixing period, 8 g of wood rosin was added to the flask. The blend was mixed for 20 minutes at 85° C. Deionized water heated to greater than 85° C. was added to the resin blend in 10 mL increments. After 370 mL of water was added, 22 g of Dowfax 2A1, an anionic alkyldiphenyloxide disulfonate, was added. The dispersion was cooled to below 40° C. and filtered through a 180 μm sieve. Another 32 g of water was added. The 55% solids dispersion had a pH of 9.2, a viscosity of 1540 cPs at 23° C. using a #4 spindle at 60 rpm and a mean particle diameter of 256 nm measured on a Microtrac UPA 150 laser diffraction instrument.

### Resin Dispersion 3—5% Additional Rosin Acid:

A 1 L resin kettle was charged with 380 g of a rosin ester resin and 2 g of butylated hydroxy toluene. The kettle was placed into a 120° C. oven until the resins were melted. Upon removal of the flask from the oven, the kettle was inserted into a heating mantle. An agitator and thermocouple were place into the flask and the molten resin blend was heated with stirring. When the temperature decreased to below 85° C., 21 g of a nonylphenol ethoxylate phosphate was added to the flask. Following approximately 5 minutes of agitation, 9 g of 45% potassium hydroxide was added to the resin mixture. Following another 5 minute mixing period, 20 g of wood rosin was added to the flask. The blend was mixed for 20 minutes at 85° C. Deionized water heated to greater than 80° C. was added to the resin blend in 10 mL increments. After 400 mL of water was added, the dispersion was cooled to below 40° C. and filtered through a 180 μm sieve. Another 20 g of water was added. The 56% solids dispersion had a pH of 9.0 and a mean particle diameter of 200 nm measured on a Microtrac UPA 150 laser diffraction instrument.

### Resin Dispersion 4—10% Additional Rosin Acid:

Identical procedure as Resin Dispersion 3 with the following changes to the quantities of raw materials used: 360 g of rosin ester resin, 22 g of nonylphenol ethoxylate phosphate, 8 g of 45% potassium hydroxide and 40 g of wood rosin. The filtered dispersion was 56% solids, had a pH of 9.0, a viscosity of 2560 cPs at 23° C. using a #4 spindle at 60 rpm and a mean particle diameter of 200 nm measured on a Microtrac UPA 150 laser diffraction instrument.

### Resin Dispersion 5—20% Additional Rosin Acid:

Identical procedure as Resin Dispersion 3 with the following changes to the quantities of raw materials used: 320 g of rosin ester resin, 22 g of nonylphenol ethoxylate phosphate, 8 g of 45% potassium hydroxide and 80 g of wood rosin. The filtered dispersion was 58% solids, had a pH of 9.0, a viscosity of 1950 cPs at 23° C. using a #4 spindle at 60 rpm and a mean particle diameter of 178 nm measured on a Microtrac UPA 150 laser diffraction instrument.

### EXAMPLES 1-4

### Adhesive Testing

Adhesive formulations were prepared containing the components shown in Table 1. Formulations were coated on a Flexcon 78BM 0-6 siliconized release paper and dried at 100° C. for 1 minute producing a dry film thickness of 0.80 mil. For room temperature adhesive testing 78 g/m² Crown Label Y paper (Crown Van Gelder Papierfabrieken N.V.) was applied to the adhesive coated release paper. The constructions were conditioned for 1 day at 23° C. and 50% relative humidity prior to testing. For humid age performance, Nover 0070 paper (Nordland Papier) was applied to the adhesive coated release paper. This paper contained 8% calcium as measured by atomic absorption.

TABLE 1
Formulations for Adhesive Testing

| Component | Description | Amount (g) |
|---|---|---|
| Robond PS7596¹ | Acrylic Latex | 140 |
| Ammonium Hydroxide, 28 wt % | Neutralent | 0.5 |
| Resin Dispersion | Tackifier Dispersion | 53 |
| Surfynol PSA336², 50 wt % | Surfactant | 1.7 |
| Polyphobe 104³, 20 wt % | Thickener | 1.0 |

¹Robond PS7596 was obtained from Rhom & Haas.
²Surfynol PSA336 was obtained from Air Products.
³Polyphobe 104 was obtained from Dow Chemical Company.

### The following test methods were utilized in the examples.

### 180° Peel Test (PSTC-101):

Five specimens (1″×12″) from each coated film were placed onto panels made of recycled corrugated cardboard and a 4.5-lb roller was passed over each specimen two times. Five minutes after preparation the specimens were pulled at a 180° angle using an Instron instrument at a rate of 12 in/min. The reported values are an average of five tests.

### Loon Tack (Modification of ASTM D-903):

The ends of 1″×12″ specimens from each coated film were placed into the grips of an Instron instrument to form a loop (adhesive side down). The specimens were lowered onto a panel made of stainless steel (SS) at a rate of 12 in/min and then raised at the same rate as tack property was measured. The reported values are an average of five tests.

### 178° Shear (PSTC-107):

Five label specimens were cut into 1″×3″ strips. A 1″×1″ square of the adhesive specimen was centered onto a stainless steel panel and two passes were done using a 4.5 lb roller. A clamp was placed on the free end of the specimen ensuring that the clamp extended completely across the width and was properly aligned to distribute the load uniformly. The specimen was then placed in the test stand and a 1000 g mass was applied to the clamp. The time elapsed in which the specimen completely separated from the test panel was recorded. The reported values are an average of five tests.

### Humid Age Exposure and Testing:

Adhesives were transfer coated onto Nover 0070 paper for humid age exposure and testing samples were cut into 1″×12″ strips and placed into an Ecosphere model EC512 from Despatch. The samples were aged for three days at 60° C. and 95% relative humidity. Following aging, the strips were conditioned at 23° C. and 50% relative humidity for one day. The mandrel test was performed by applying 1″×1.5″ specimens to a ⅜″ diameter high density polyethylene mandrel. The mandrels were rotated two complete revolutions under a 4.5 lb weight. The mandrels were exposed to 60° C. and 95% relative humidity for specified periods of time. At the designated times the mandrels were removed from the humidity chamber and the edge lift was measured. At conclusion of the measurements, the mandrels were returned to the humidity chamber and the testing resumed. Total edge lift from the mandrel is the sum of the lifts from both edges of the label. The reported values are an average of five tests.

TABLE 2
Pressure Sensitive Adhesive Results

| | Example | | | | |
|---|---|---|---|---|---|
| | Comparative | 1 | 2 | 3 | 4 |
| Resin Dispersion | 1 | 2 | 3 | 4 | 5 |
| Wood rosin in dispersion (%) | 0 | 2 | 5 | 10 | 20 |
| 180° Peel to Recycled | Paper Tear | Paper | Paper | Paper | Paper |
| Corrugated Cardboard (lb/in) | | Tear | Tear | Tear | Tear |
| Loop tack to Low Density | 1.5 | 1.3 | 1.4 | 1.5 | 1.0 |
| Polyethylene (LDPE) (lb/in²) | | | | | |
| 178° Shear (hr.) | 4 | 13 | 6 | 4 | 4 |
| 3 hr. Post-humid Age | 0 | 0 | 0 | 0 | 0 |
| ⅜″ HDPE Mandrel | | | | | |
| (mm of edge lift) | | | | | |
| 24 hr. Post-humid Age | 14 | 16 | 4 | 1 | 0 |
| ⅜″ HDPE Mandrel | | | | | |
| (mm of edge lift) | | | | | |
| 72 hr. Post-humid Age | 32 | 32 | 32 | 32 | 0 |
| ⅜″ HDPE Mandrel | | | | | |
| (mm of edge lift) | | | | | |

Table 2 summarizes the adhesion properties of the adhesives formulated according to Table 1 using Resin Dispersions 1-5. The 180° peel test, loop tack, and 178° shear demonstrate how all four of the formulations containing the resin dispersions with varying wood rosin levels behave as pressure sensitive adhesives. In particular, following humid age exposure on the calcium-rich paper, the HDPE mandrel test shows that the acid level has an effect on the adhesive properties of the formulations. As the carboxylic acid level in the dispersion formulation increases, the labels show improved adhesion to the HDPE mandrels both as a function of acid level as well as time. In fact, complete retention of the labels to the rod after 72 hours is only observed in the formulation composed of the resin dispersion containing 20% wood rosin.

The invention has been described in detail with particular reference to preferred embodiments thereof, but it will be understood that variations and modifications can be effected within the spirit and scope of the invention.

What is claimed is:

1. A process for producing a resin dispersion comprising:
(a) melting a resin;
(b) contacting the resin with a least one surfactant;
(c) neutralizing the surfactant(s) with at least one neutralizing agent;
(d) adding a low molecular weight carboxylic acid containing compound to the resin mixture; and
(e) adding water to invert the dispersion.

2. A process for producing a resin dispersion comprising:
(a) melting a resin
(b) adding a low molecular weight carboxylic acid containing compound to the resin;
(c) contacting the resin mixture with a least one surfactant; and
(d) adding water to invert the dispersion.

3. The process of claim 1 or 2, wherein the concentration of the carboxylic acid compound is greater than about 2% by weight.

4. The process of claim 1 or 2, wherein the concentration of the carboxylic acid compound is greater than about 5% by weight.

5. The process of claim 1 or 2, wherein the carboxylic acid containing compound is in a non-neutralized form.

6. The process of claim 1 or 2, wherein the carboxylic acid containing compound has low volatility.

7. The process of claim 1 or 2, wherein the resin is one or more of hydrocarbon resins, pentaerythritol, glycerols or triethylene glycol esters of rosin.

8. The process of claim 1 or 2, wherein the low molecular weight carboxylic acid containing compound is one or more of rosin acids, hydrogenated rosin acids, dimerized rosin acids or modified rosin acids.

9. The process of claim 8, wherein the low molecular weight carboxylic acid containing compound is a wood rosin.

10. The process according to claim 1 or 2, wherein the low molecular weight carboxylic acid containing compound is added in an amount from about 2% to about 20%, by weight.

11. The process according to claim 1 or 2, wherein the carboxylic acid containing compound is added in an amount up to about 10%.

12. The process according to claim 1 or 2, wherein the carboxylic acid containing compound is added in an amount up to about 20%.

13. The process according to claim 1, wherein at least one surfactant is ionic.

14. The process according to claim 13, wherein the ionic surfactant is any carboxylic acid containing compound, any phosphoric acid containing compound, any sulfuric acid containing compound, any alkyl sulphonates, any fatty alcohol sulphate containing compounds, any sulfonic acid containing compound, any sulfonate succinic acid containing compound, any sulfosuccinic acid containing compound, or any sulfosuccinamic acid containing compound, or any disulfosuccinic acid containing compound.

15. The process according to claim 13, wherein the ionic surfactant is any carboxylic acid containing compound, any phosphoric acid containing compound, or any sulfuric acid containing compound.

16. The process according to claim 15, wherein the ionic surfactant is a rosin acid, a hydrogenated rosin acid, a disproportionated rosin acid, or a modified rosin acid.

17. The process according to claim 16, wherein the ionic surfactant is a wood rosin.

18. The process according to claim 2, wherein the surfactant is one or more of the following of any long chain ethoxylate block copolymers, any hydroxyl terminal long chain ethoxylates, alcohol ethoxylates, alkyl ethoxylates, alkyl phenols, alkyl phenol ethoxylates, alkyl alcohol ethoxylates, alkyl sulphonates, fatty alcohol sulphates, alkyl phenol ethoxylate phosphates, or phosphate esters.

19. The process according to claim 2, wherein the surfactant comprises a nonylphenol ethoxylate phosphate.

20. The process according to claim 19, wherein the nonylphenol is selected from the group consisting of 4-nonylphenol with a varied and undefined degree of branching in the attached alkyl group, alkylsulfonic acid, fatty acid, oxyethylated alkyphenol and derivatives, or mixtures thereof.

21. The process according to claim 1, wherein the neutralizing agent is an amine or an alkali metal hydroxide.

22. The process according to claim 1 or 2, wherein the low molecular weight carboxylic acid containing compound acts as a scavenger for migrating multivalent cations in adhesive formulations.

23. A water based pressure sensitive adhesive formulation comprising a resin dispersion made according to the process of claim 1 or 2 compounded with a polymer latex at a concentration of about 10% to about 60% on a dry weight basis.

24. A process for producing a tackifier dispersion comprising dispersing resinous material such as rosin ester resins in an aqueous phase containing at least one neutralized ionic surfactant or at least one nonionic surfactant and introducing about 5% or more by weight of a non-neutralized low molecular weight carboxylic acid containing compound to the resin mixture.

25. An adhesive containing a tackifier dispersion made according to the process of claim 1 or 2.

26. An adhesive composition comprising: a resin dispersion of claim 1 or 2;
a polymer latex; and water.

27. The resin dispersion of claim 1.

28. The resin dispersion of claim 2.

29. A pressure sensitive adhesive composition comprising a surfactant, a tackifier resin dispersion, a polymer latex, and water, wherein the dispersion is prepared by a process comprising dispersing one or more of hydrocarbon resins, pentaerythritol, glycerols, or triethylene glycol esters of rosin in an aqueous phase containing a nonylphenol surfactant and introducing about 2% or more by weight of a low molecular weight compound such as rosin acids, hydrogenated rosin acids, modified rosin acids, disproportionated rosin acids or dimerized rosin acids to the resin mixture, wherein the low molecular weight compound acts as a scavenger in the adhesive such that migrating multivalent cations react with the low molecular weight compound instead of crosslinking with the adhesive polymer.

30. A pressure sensitive adhesive composition comprising a surfactant, a tackifier resin dispersion, a polymer latex, and water, wherein the dispersion is prepared by a process comprising dispersing one or more of hydrocarbon resins, pentaerythritol, glycerols, or triethylene glycol esters of rosin in an aqueous phase containing a neutralized ionic surfactant and introducing about 2% or more by weight of a non-neutralized low molecular weight compound such as a rosin acid, a hydrogenated rosin acid, a modified rosin acid, a disproportionated rosin acid or a dimerized rosin acid to the resin mixture, wherein the low molecular weight compound acts as a scavenger in the adhesive such that migrating multivalent cations react with the low molecular weight compound instead of crosslinking with the adhesive polymer.

31. A pressure sensitive adhesive overlay prepared by applying a layer of adhesive composition to a surface of a paper substrate, and drying the layer, wherein the adhesive composition comprises a tackifier resin dispersion, a polymer latex, and water, wherein the resin dispersion is prepared by a process comprising: dispersing one or more of hydrocarbon resins, pentaerythritol, glycerols, or triethylene glycol esters of rosin in an aqueous-phase containing a nonylphenol and introducing about 2% or more by weight of a wood rosin to the resin, wherein the wood rosin acts as a scavenger in the adhesive such that migrating multivalent cations liberated from the substrate react with the wood rosin instead of crosslinking with the adhesive polymer.

32. A pressure sensitive adhesive overlay prepared by applying a layer of adhesive composition to a surface of a paper substrate, and drying the layer, wherein the adhesive composition comprises a tackifier resin dispersion, a polymer latex, and water, wherein the resin dispersion is prepared by a process comprising: dispersing one or more of hydrocarbon resins, pentaerythritol, glycerols, or triethylene glycol esters of rosin in an aqueous phase containing a neutralized wood rosin and introducing about 2% or more by weight of a non-neutralized wood rosin to the resin, wherein the wood rosin acts as a scavenger in the adhesive such that migrating multivalent cations liberated from the substrate react with the wood rosin instead of crosslinking with the adhesive polymer.

33. The pressure sensitive adhesive overlay of claim 31 or 32, wherein the overlay maintains its cohesive strength overtime.

34. The pressure sensitive adhesive overlay of claim 31 or 32, wherein little or no edge lift is observed from plastic mandrels following humid age exposure of labels affixed with the overlay.

35. The pressure sensitive adhesive overlay of claim 31 or 32, wherein the tackifier dispersion is compounded with the polymer latex at a concentration of about 10% to about 60% by weight on a dry weight basis.
